(19) United States
(12) Patent Application Publication
(10) Pub. No.: US 2019/0180758 A1
(43) Pub. Date: Jun. 13, 2019

(54) VOICE PROCESSING APPARATUS, VOICE PROCESSING METHOD, AND NON-TRANSITORY COMPUTER-READABLE STORAGE MEDIUM FOR STORING PROGRAM

(71) Applicant: FUJITSU LIMITED, Kawasaki-shi (JP)

(72) Inventor: Nobuyuki WASHIO, Akashi (JP)

(73) Assignee: FUJITSU LIMITED, Kawasaki-shi (JP)

(21) Appl. No.: 16/212,106

(22) Filed: Dec. 6, 2018

(30) Foreign Application Priority Data
Dec. 8, 2017 (JP) 2017-235977

(51) Int. Cl. G10L 17/00; G10L 15/26; G10L 13/08; G06F 17/28

(52) U.S. Cl. CPC G10L 17/005; G06F 17/289; G10L 13/086; G10L 15/265

(57) ABSTRACT

A voice processing apparatus detects, based on at least one of a first voice signal generated by a first voice input unit and a second voice signal generated by a second voice input unit, start timing of utterance by any one of a plurality of speakers; determines, based on at least one of the first voice signal and the second voice signal on and after the detected start timing of utterance, whether or not to modify the start timing of utterance; identifies, based on the first voice signal and the second voice signal on and after the modified start timing of utterance, a speaker who has uttered out of the plurality of speakers; and executes a process in accordance with the identified speaker on at least one of the first voice signal and the second voice signal on and after the modified start timing of utterance.

### CROSS-REFERENCE TO RELATED APPLICATION

This application is based upon and claims the benefit of priority of the prior Japanese Patent Application No. 2017-235977, filed on Dec. 8, 2017, the entire contents of which are incorporated herein by reference.

### FIELD

The embodiments discussed herein are related to, for example, a voice processing apparatus that processes a voice signal representing a voice of a speaker, a voice processing method, and a non-transitory computer-readable storage medium for storing a program.

### BACKGROUND

Applications are being developed for recognizing words and phrases uttered by a speaker from a voice signal, translating the recognized words and phrases into another language, and searching a network or a database for the recognized words and phrases as a query. In such applications, an utterance section by a speaker in the voice signal is detected, and voice processing is performed on the detected section in accordance with respective applications.

In some cases, each voice of a plurality of speakers is subjected to voice processing, and processing to be performed differs in accordance with a speaker. Thus, a technique is proposed that separates voice signals of two or more users input into a voice input unit for each user, recognizes a voice signal for each separated user, and displays a recognition result to a display area corresponding to each user on a display unit (for example, refer to Japanese Laid-open Patent Publication No. 2015-106014).

### SUMMARY

According to an aspect of the embodiments, a voice processing apparatus includes: a memory; and a processor coupled to the memory and configured to execute an utterance section start detection process that includes based on at least one of a first voice signal generated by a first voice input unit and a second voice signal generated by a second voice input unit, detecting start timing of utterance by any one of a plurality of speakers, execute a start timing modification process that includes based on at least one of the first voice signal and the second voice signal on and after the detected start timing of utterance, determining whether or not to modify the start timing of utterance, execute a speaker identification process that includes when the start timing of utterance is modified, based on the first voice signal and the second voice signal on and after the modified start timing of utterance, identifying a speaker who has uttered out of the plurality of speakers, and execute a voice process that includes executing a process in accordance with the identified speaker on at least one of the first voice signal and the second voice signal on and after the modified start timing of utterance.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic configuration diagram of a voice processing apparatus according to an embodiment;

FIG. 2 is a functional block diagram of a processor of the voice processing apparatus regarding voice processing;

FIG. 3 is an explanatory diagram for identifying a speaker according to the present embodiment;

FIG. 4 is an explanatory diagram for modifying utterance section start timing;

FIG. 5 is a diagram illustrating an example of a corresponding relationship between a speaker and voice processing;

FIG. 6 is a diagram illustrating an example of a relationship between modification of utterance section start timing and voice processing;

FIG. 7 is a flowchart of operation of the voice processing; and

FIG. 8 is a schematic configuration diagram of a server client system in which a voice processing apparatus according to an embodiment or a variation thereof is implemented.

### DESCRIPTION OF EMBODIMENTS

However, the magnitude of a noise component included in a voice signal varies in accordance with the ambient environment of an apparatus that performs voice processing. Accordingly, although a speaker has not started utterance, start timing of utterance by a speaker is sometimes mistakenly detected due to noise included in the voice signal. In such a case, by the above-described technique, if the other of the speakers starts utterance during a section separated as a voice of one of the speakers who actually has not uttered in voice signals, a section in which the other of the speakers is uttering is also associated with the speaker who has not uttered. As a result, a section including a voice of a speaker who is uttering is sometimes subjected to voice processing for a speaker who is not uttering.

According to one aspect of the disclosure, it is desirable to provide a voice processing apparatus capable of applying processing in accordance with a speaker who has uttered to a voice signal even if start timing of utterance by any one of a plurality of speakers is mistakenly detected in the voice signal.

In the following, a description will be given of a voice processing apparatus according to embodiments with reference to the drawings. The voice processing apparatus detects a section (hereinafter referred to simply as an utterance section) in which any one of a plurality of speakers has uttered in a voice signal and identifies a speaker who has uttered in the detected utterance section. The voice processing apparatus performs processing on the utterance section in accordance with the identified speaker. The voice processing apparatus determines whether or not to modify the start timing of the utterance section based on a voice signal after detection of the start of the utterance section in preparation for the case where start timing of an utterance section is mistakenly detected due to variation of the magnitude of noise, or the like. When the voice processing apparatus modifies the start timing of the utterance section, the voice processing apparatus identifies a speaker who has uttered once again on the assumption that the actual utterance section has started from the modified start timing. The voice processing apparatus performs processing in accordance with the speaker identified once again on the utterance section on and after the start timing detected once again.

It is possible to implement the voice processing apparatus on various apparatuses that employ a user interface using a voice signal, for example, a navigation system, a telephone conference system, a mobile phone, a computer, and the like. In the present embodiment, it is assumed that the voice processing apparatus is implemented on a multilingual translation apparatus that performs translation processing for a language different for each speaker.

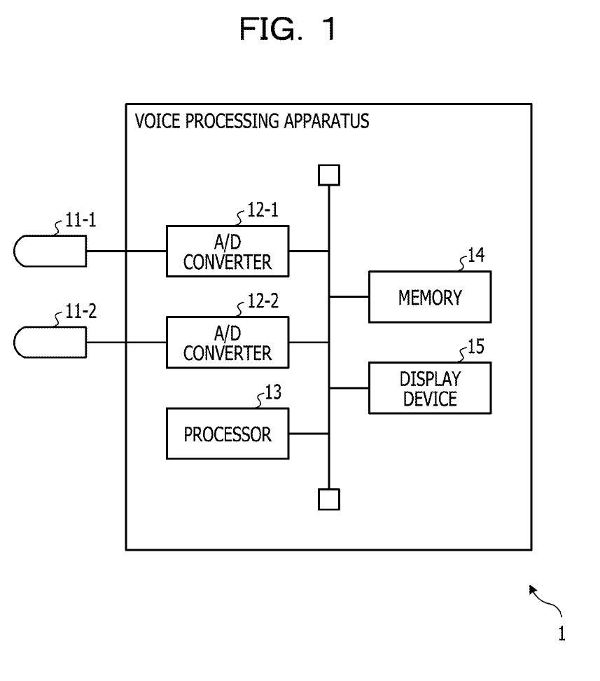

FIG. 1 is a schematic configuration diagram of a voice processing apparatus according to an embodiment. The voice processing apparatus 1 includes two microphones 11-1 and 11-2, two analog-digital converters 12-1 and 12-2, a processor 13, a memory 14, and a display device 15. The voice processing apparatus 1 may further include a communication interface (not illustrated in the figure) for communicating with a speaker (not illustrated in the figure) and the other devices.

The microphones 11-1 and 11-2 are examples of a voice input unit respectively and are disposed at a predetermined interval with each other. For example, the microphone 11-1 is disposed at a nearer place to one (for convenience, referred to as a first speaker) of a plurality of speakers than the microphone 11-2. The microphone 11-2 is disposed at a nearer place to the other (for convenience, referred to as a second speaker) of the plurality of speakers than the microphone 11-1. The microphones 11-1 and 11-2 collect ambient sounds of the voice processing apparatus 1 including a voice of any one of the plurality of speakers and generate analog voice signals in accordance with the intensity of the sounds. The microphone 11-1 outputs the analog voice signal to the analog-digital converter (hereinafter referred to as an A/D converter) 12-1. In the same manner, the microphone 11-2 outputs the generated analog voice signal to the A/D converter 12-2.

The A/D converter 12-1 samples the analog voice signal received from the microphone 11-1 at a predetermined sampling rate so as to digitize the voice signal. The sampling rate is set, for example, so that a frequency band demanded for analyzing a voice of a speaker from a voice signal becomes lower than or equal to the Nyquist frequency, for example, at 16 kHz to 32 kHz. The A/D converter 12-1 outputs a digitized voice signal to the processor 13. In the same manner, the A/D converter 12-2 samples the analog voice signal received from the microphone 11-2 at a predetermined sampling rate so as to digitize the voice signal and output the digitized voice signal to the processor 13.

In the following, a voice signal received from the microphone 11-1 and digitized by the A/D converter 12-1 is referred to as a first voice signal, and a voice signal received from the microphone 11-2 and digitized by the A/D converter 12-2 is referred to as a second voice signal.

The processor 13 includes, for example, a central processing unit (CPU), a readable and writable memory circuit, and a peripheral circuit thereof. The processor 13 may further include an arithmetic operation circuit. The processor 13 detects an utterance section in which any one of the speakers has uttered from the first voice signal and the second voice signal and identifies a speaker who is uttering in the utterance section. The processor 13 performs voice recognition processing for the language corresponding to an identified speaker with respect to the utterance section and translates the recognized words and phrases into a language other than the language corresponding to the identified speaker and displays the translation result to the display device 15.

Further, after the processor 13 detects start timing of an utterance section once, the processor 13 determines whether or not to modify the start timing of the utterance section. When the start timing of the utterance section is modified, the processor 13 identifies a speaker who is uttering once again based on the first and the second voice signals on and after the modified start timing of the utterance section. The processor 13 performs voice recognition processing and translation processing for a language corresponding to the speaker identified once again on the utterance section on and after the modified start timing. The details of the voice processing will be described later.

The memory 14 includes, for example, a readable and writable non-volatile semiconductor memory and a readable and writable volatile semiconductor memory. Further, the memory 14 may include a magnetic recording medium or an optical recording medium and the access devices thereof. The memory 14 stores various kinds of data for use in the voice processing performed by the processor 13 and various kinds of data generated in the middle of the voice processing.

It is possible to use, for example, a liquid crystal display or an organic EL display for the display device 15. The display device 15 displays display data received from the processor 13, for example, the contents of the utterance by any one of the speakers or a character string obtained by translating the contents of a language (for example, Japanese) used by the speaker into another language (for example, English).

In the following, a description will be given of the details of the processor 13.

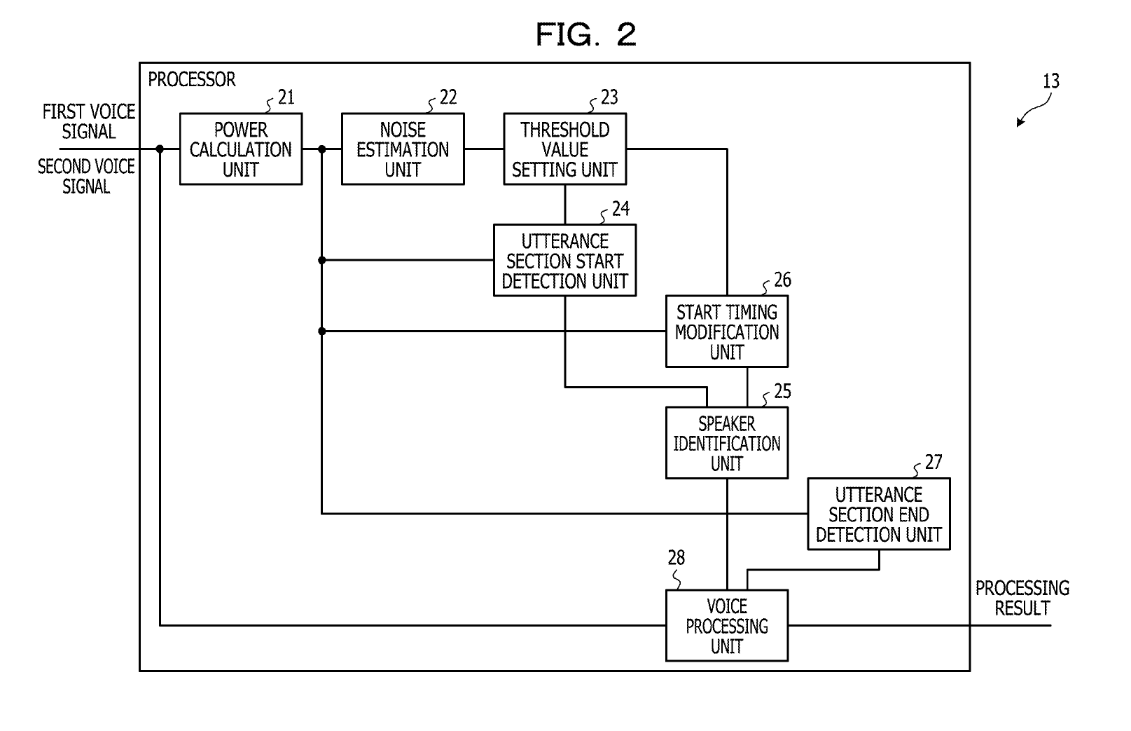

FIG. 2 is a functional block diagram of the processor 13 regarding voice processing. The processor 13 includes a power calculation unit 21, a noise estimation unit 22, a threshold value setting unit 23, an utterance section start detection unit 24, a speaker identification unit 25, a start timing modification unit 26, an utterance section end detection unit 27, and a voice processing unit 28. Each unit of the processor 13 is a functional module that is realized, for example, by executing a computer program running on the processor 13. Alternatively, each unit of the processor 13 may be incorporated in the processor 13 as a dedicated circuit of the function of each unit.

The processor 13 performs voice processing on each of the first and the second voice signals with a frame having a predetermined length as a processing unit. The frame length is set, for example, at 10 msec to 20 msec. Accordingly, the processor 13 divides each of the first and the second voice signals for each frame and inputs each frame into the power calculation unit 21 and the voice processing unit 28.

The power calculation unit 21 calculates the power of the frame for each of the first and the second voice signals each time a frame is input. The power calculation unit 21 calculates power, for example, in accordance with the following expression for each frame:

$$Spow ( k ) = {\sum }_{n = 0}^{N - 1} {{s}_{k} ( n )}^{2} \qquad ( 1 )$$

where Sk(n) denotes a signal value of the n-th sampling point of the latest frame (also referred to as the current frame), the sign k denotes a frame number, and N denotes the total number of the sampling points included in a frame. Spow(k) denotes the power of the current frame.

The power calculation unit 21 may calculate power of each frame for each of a plurality of frequencies. In this case, the power calculation unit 21 converts the first and the second voice signals for each frame from the time domain to spectrum signals in the frequency domain using time-frequency conversion. It is possible for the power calculation unit 21 to use, for example, fast Fourier transform (FFT) for the time-frequency conversion. It is possible for the power calculation unit 21 to calculate the sum of squares of the spectrum signals included in the frequency for each frequency of each of the first and the second voice signals as power of the frequency. The power calculation unit 21 may calculate the sum of power of each frequency included in the frequency band (for example, 100 Hz to 20 kHz) including human voices for each frame as power of the frame.

The power calculation unit 21 outputs power for each frame of each of the first and the second voice signals to the noise estimation unit 22, the utterance section start detection unit 24, the speaker identification unit 25, the start timing modification unit 26, and the utterance section end detection unit 27.

The noise estimation unit 22 calculates estimated noise components in the voice signal in the frame of each of the first and the second voice signals for each frame. In the present embodiment, the noise estimation unit 22 updates the estimated noise components in the immediately preceding frame using the power of the current frame in accordance with the following expression so as to calculate an estimated noise component of the current frame:

Noise(k)=β·Noise(k−1)+(1−β)·Spow(k) (2)

where Noise(k−1) denotes an estimated noise component in the immediately preceding frame, and Noise(k) denotes an estimated noise component in the current frame. The sign β denotes a forgetting factor and is set to, for example, 0.9.

In the case where power is calculated for each frequency, the noise estimation unit 22 may calculate an estimated noise component for each frequency in accordance with the expression (2). In this case, in the expression (2), Noise(k−1), Noise(k), and Spow(k) are an estimated noise component of the immediately preceding frame for a focused frequency, an estimated noise component of the current frame, and power respectively.

The noise estimation unit 22 outputs the estimated noise component for each frame of each of the first and the second voice signals to the threshold value setting unit 23. The utterance section start detection unit 24 described later sometimes determines that the current frame is a frame included in an utterance section including a voice of any one of the speakers. In this case, the noise estimation unit 22 may replace the estimated noise component Noise(k) of the current frame with Noise(k−1). Thereby, it is possible for the noise estimation unit 22 to estimate a noise component based on a frame estimated to include only a noise component and not to include a signal component, and thus it is possible to improve the estimation precision of a noise component.

Alternatively, the noise estimation unit 22 ought to update the estimated noise component in accordance with the expression (2) only when the power of the current frame is lower than or equal to a predetermined threshold value. When the power of the current frame is higher than the predetermined threshold value, the noise estimation unit 22 ought to consider that Noise(k)=Noise(k−1). It is possible to determine the predetermined threshold value to be, for example, the sum of Noise(k−1) and a predetermined offset value.

The threshold value setting unit 23 sets a threshold value for detecting an utterance section for each of the first and the second voice signals based on the estimated noise component. For example, the threshold value setting unit 23 sets a threshold value for each frame while an utterance section is not detected. For example, the threshold value setting unit 23 determines the sum of the estimated noise component of the current frame for the first voice signal and a predetermined offset value as a threshold value for the first voice signal. In the same manner, the threshold value setting unit 23 ought to determine the sum of the estimated noise component of the current frame for the second voice signal and a predetermined offset value as a threshold value for the second voice signal.

Alternatively, the threshold value setting unit 23 may determine the sum of the average value between the estimated noise component of the first voice signal of the current frame and the estimated noise component of the second voice signal of the current frame and a predetermined offset value as a threshold value common to the first voice signal and the second voice signal. Alternatively, the threshold value setting unit 23 may determine the sum of a larger one of the estimated noise component of the first voice signal of the current frame and the estimated noise component of the second voice signal of the current frame and a predetermined offset value as a threshold value common to the first voice signal and the second voice signal.

The threshold value setting unit 23 notifies the utterance section start detection unit 24 of a threshold value for each frame until a start of an utterance section is detected for each of the first and the second voice signals.

The utterance section start detection unit 24 compares at least one of power of the first voice signal and the second voice signal of the frame with a threshold value for each frame so as to detect start timing of an utterance section.

For example, when both power of the first and the second voice signals are less than corresponding threshold values up to the immediately preceding frame, and if the power of the current frame becomes equal to or higher than a corresponding threshold value for at least one of the first and the second voice signals, the utterance section start detection unit 24 determines that an utterance section has started. The utterance section start detection unit 24 determines the current frame to be start timing of an utterance section.

Alternatively, the utterance section start detection unit 24 may compare a signal having larger power out of the first voice signal and the second voice signal for each frame with a corresponding threshold value. When a signal having larger power becomes less than a corresponding threshold value up to the immediately preceding frame, and if a signal having larger power becomes equal to or higher than a corresponding threshold value in the current frame, the utterance section start detection unit 24 may detect an utterance section of the current frame as start timing.

Alternatively, if at least one of the first voice signal and the second voice signal becomes to have power equal to or higher than a corresponding threshold value consecutively over a predetermined number of frames, the utterance section start detection unit 24 may determine that an utterance section has started. The utterance section start detection unit 24 may detect a frame of which power has become equal to or higher than a threshold value first out of the consecutive frames as start timing of an utterance section.

If the utterance section start detection unit 24 determines that an utterance section has started, the utterance section start detection unit 24 notifies the speaker identification unit 25 and the start timing modification unit 26 of the incidence.

When a start of an utterance section is detected, the speaker identification unit 25 identifies a speaker who is uttering in the utterance section. For example, the speaker identification unit 25 calculates the average value of power of a predetermined number of (for example, 1 to 5) of frames immediately after the utterance section start detection for each of the first and the second voice signals. The speaker identification unit 25 determines that a speaker (for example, a speaker who is closer to the microphone) corresponding to a microphone that has obtained a voice signal having the higher average value of power has uttered out of the microphones 11-1 and 11-2.

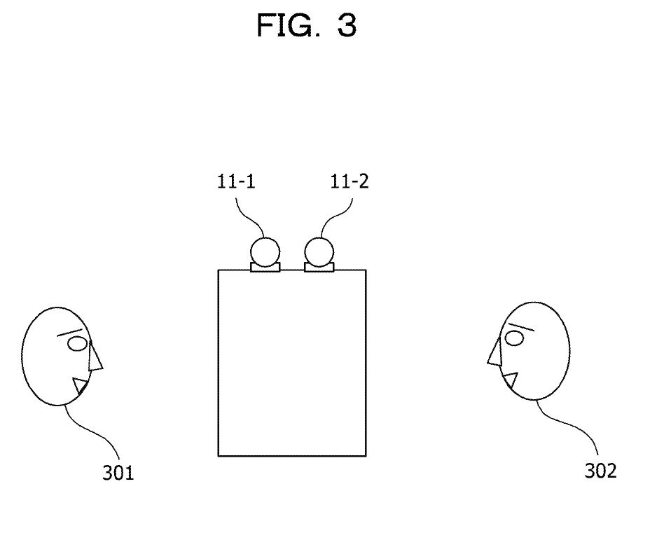

FIG. 3 is an explanatory diagram for identifying a speaker according to the present embodiment. In this example, each microphone is disposed in the order of a microphone 11-1 and a microphone 11-2 from left. A first speaker 301 is positioned on the left of the microphone 11-1, and a second speaker 302 is positioned on the right of the microphone 11-2. Accordingly, the microphone 11-1 is disposed closer to the first speaker 301 than the microphone 11-2. Thus, when a first speaker 301 utters, it is estimated that power of a first voice signal collected by the microphone 11-1 is larger than the power of a second voice signal collected by the microphone 11-2. Accordingly, immediately after the detection of an utterance section start, if the average value of the power of the first voice signal is higher than the average value of the power of the second voice signal, a determination is made that the first speaker 301 is uttering.

In the same manner, the microphone 11-2 is closer to the second speaker 302 than the microphone 11-1. Accordingly, when the second speaker 302 utters, it is estimated that power of the second voice signal collected by the microphone 11-2 is larger than the power of the first voice signal collected by microphone 11-1. Accordingly, immediately after the detection of an utterance section start, if the average value of the power of the second voice signal is higher than the average value of the first voice signal, a determination is made that the second speaker 302 is uttering.

If it is assumed that there are three speakers, the speaker identification unit 25 may determine any one of the three speakers based on a comparison result between the average value of power of the first voice signal immediately after detection of an utterance section start and the average value of power of the second voice signal. For example, the speaker identification unit 25 compares the absolute value of the difference between the average value of the power of the first voice signal and the average value of the power of the second voice signal with a predetermined power difference threshold value. If the absolute value of the difference is less than or equal to the power difference threshold value, the speaker identification unit 25 may determine that a speaker positioned in the normal direction to the arrangement direction of the microphone 11-1 and the microphone 11-2 has uttered. On the other hand, if the absolute value of the difference is higher than the power difference threshold value, and the average value of the power of the first voice signal is higher than the average value of the power of the second voice signal, the speaker identification unit 25 determines that a speaker positioned closer to the microphone 11-1 than the microphone 11-2 has uttered. If the absolute value of the difference is higher than the power difference threshold value, and the average value of the power of the second voice signal is higher than the average value of the power of the first voice signal, the speaker identification unit 25 determines that a speaker positioned closer to the microphone 11-2 than the microphone 11-1 has uttered.

Alternatively, the speaker identification unit 25 may estimate a sound source direction based on the first voice signal and the second voice signal in a predetermined number of frames immediately after a start of an utterance section and determine that a speaker in the estimated sound source direction is uttering. In this case, the speaker identification unit 25 calculates, for example, a normalized cross-correlation value between the first voice signal and the second voice signal for a predetermined number of frames immediately after detection of an utterance section start while shifting the time difference with each other. The speaker identification unit 25 identifies the time difference that produces the highest normalized cross-correlation value as a delay time. The speaker identification unit 25 ought to estimate the sound source direction based on the distance between the microphone 11-1 and the microphone 11-2, and the delay time. If the estimated sound source direction faces closer to the microphone 11-1 than the normal direction of the arrangement direction of the microphone 11-1 and the microphone 11-2, the speaker identification unit 25 determines that a speaker positioned closer to the microphone 11-1 than the microphone 11-2 has uttered. Hereinafter the normal direction with respect to the arrangement direction of the microphone 11-1 and the microphone 11-2 is referred to as the normal direction with respect to the arrangement direction of the microphones. On the other hand, if the estimated sound source direction faces closer to the microphone 11-2 than the normal direction of the arrangement direction of the microphones, the speaker identification unit 25 determines that a speaker positioned closer to the microphone 11-2 than the microphone 11-1 has uttered. When it is assumed that there are three speakers, if the angle formed by the estimated sound source direction and the normal direction of the arrangement direction of the microphones is less than ±45°, the speaker identification unit 25 may determine that a speaker positioned in the normal direction has uttered. If the angle formed by the estimated sound source direction and the normal direction of the arrangement direction of the microphones is equal to or higher than 45°, and the estimated sound source direction faces closer to the microphone 11-1 than the normal direction, the speaker identification unit 25 determines that a speaker positioned closer to the microphone 11-1 has uttered. Further, the angle formed by the estimated sound source direction and the normal direction of the arrangement direction of the microphones is equal to or higher than 45°, and the estimated sound source direction faces closer to the microphone 11-2 than the normal direction, the speaker identification unit 25 determines that a speaker positioned closer to the microphone 11-2 has uttered.

If the start timing modification unit 26 modifies the start timing of an utterance section, the speaker identification unit 25 performs the same processing as described above on the first and the second voice signals of a predetermined number of frames from the modified start timing of the utterance section and identifies a speaker once again.

The speaker identification unit 25 notifies the voice processing unit 28 of the identified speaker.

The start timing modification unit 26 determines whether or not to modify the start timing of the utterance section based on each of the first and the second voice signals from the detection of a start of an utterance section by the utterance section start detection unit 24.

The utterance section start detection unit 24 sometimes mistakenly detects timing of an abrupt increase of noise as start timing of an utterance section due to an abrupt increase of noise. After start timing of an utterance section is mistakenly detected, if any one of the speakers starts an utterance, the power of the first and the second voice signals further increases after an actual start of an utterance. Thus, the maximum value of the power of the first and the second voice signals in an actual utterance section becomes relatively large with respect to the power of the first and the second voice signals immediately after the start timing of a mistakenly detected utterance section.

On the other hand, while any one of the speakers continues uttering, a voice of the speaker is included in the first and the second voice signals, and thus the power of the first and the second voice signals while any one of the speakers continues uttering does not decrease so much compared with the maximum value of the power.

Thus, the start timing modification unit 26 detects the maximum value of the power of each of the first and the second voice signals after detection of a start of an utterance section. If a predetermined number of frames having the amount of decrease in power equal to or larger than a predetermined power difference with respect to the maximum value of the detected power continue, the start timing modification unit 26 modifies the first frame out of the consecutive frames to the start timing of the utterance section. The start timing modification unit 26 updates a threshold value for detecting an utterance section for each of the first and the second voice signals with the difference when the predetermined power the difference is subtracted from the maximum value of power. The predetermined power difference is set to, for example, the difference between the maximum value of power assumed to be a voice of the speaker and the minimum value of power while any one of the speakers continues uttering.

The start timing modification unit 26 may directly use the value calculated by the power calculation unit 21 as the power of each frame used for modification determination of start timing of an utterance section. Alternatively, the start timing modification unit 26 may use a value produced by subtracting the estimated noise component from the value calculated by the power calculation unit 21 as power of each frame used for the modification determination. Alternatively, the start timing modification unit 26 may calculate the moving average value of power as power of each frame used for the modification determination and use the moving average value.

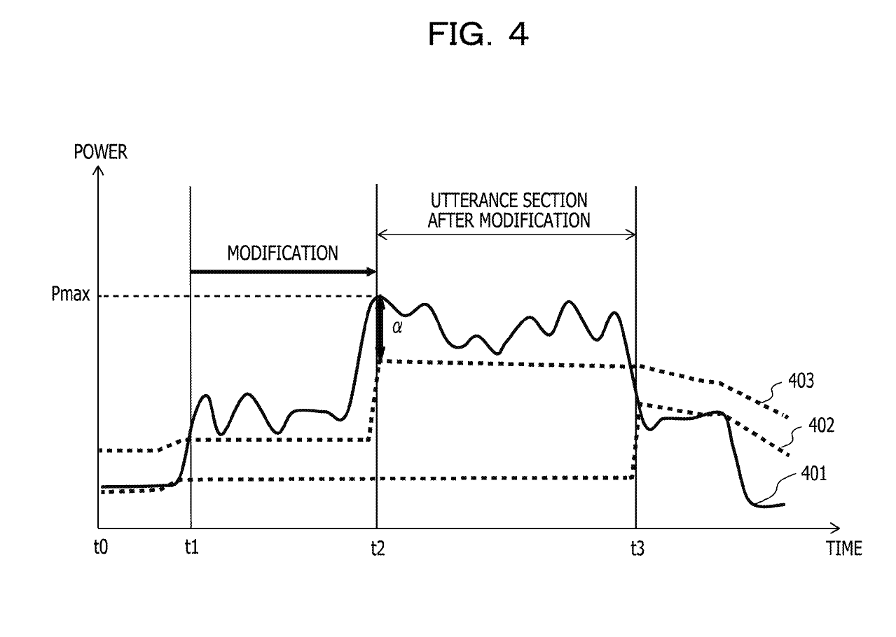

FIG. 4 is an explanatory diagram for modifying utterance section start timing. In FIG. 4, the horizontal axis represents time, and the vertical axis represents power. A waveform 401 indicates change of power of a focused voice signal with time. A waveform 402 indicates change of power of the estimated noise component with time. Further, a waveform 403 indicates change of threshold value Th for detection of an utterance section with time.

In this example, the power of the focused voice signal is less than the threshold value Th from time t0 to time t1, and thus a determination is made that there is no utterance section from time t0 to time t1. Immediately before time t1, for example, a noise abruptly increases so that the power of the focused voice signal rises. At this time, since an increase of noise is abrupt, and thus the increase of noise is not reflected on the threshold value Th, and as a result, the power of the focused voice signal becomes equal to or larger than the threshold value Th at time t1. Thus, the utterance section start detection unit 24 determines that an utterance section has started at time t1.

Immediately before time t2 after time t1, any one of the speakers actually starts an utterance so that the power of focused voice signal further increases immediately before time t2. As a result, in each frame on and after time t2, the threshold value Th becomes less than a value (Pmax−α), which is a value produced by decreasing from the maximum value Pmax of the power in the utterance section by a predetermined power difference α. Thus, the start timing of the utterance section is modified at time t2. The threshold value Th is updated with (Pmax−α). After that, after detection of the start of an utterance section, at time t3 in the immediately preceding frame of the first frame, in which the power of the focused voice signal becomes less than the threshold value Th after the update, a determination is made that the utterance section has ended.

In this manner, the threshold value Th is updated so that a section from time t1 to time t2, which includes only noise, is excluded from the utterance section, and thus the utterance section is obtained correctly.

With a variation, the start timing modification unit 26 may perform the processing described above only on a voice signal having a larger maximum power value after detection of an utterance section start out of the first and the second voice signals and determine whether or not to modify the start timing of the utterance section. This is because it is assumed that a voice signal having a higher maximum value of power after detection of a start of an utterance section includes more voices of speakers who are uttering than the other of the voice signals. In this manner, by determining whether or not to modify start timing of an utterance section based on only one of the voice signals, it is possible for the start timing modification unit 26 to reduce the amount of computation.

When the start timing modification unit 26 modifies the start timing of an utterance section, the start timing modification unit 26 notifies the speaker identification unit 25 of the modification. When the speaker identification unit 25 is notified of the modification of the start timing of an utterance section, the speaker identification unit 25 identifies a speaker who is uttering in the utterance section once again. Further, when the start timing modification unit 26 modifies the start timing of the utterance section, the start timing modification unit 26 notifies the utterance section end detection unit 27 of the updated threshold value Th for each of the first and the second voice signals.

The utterance section end detection unit 27 determines whether or not the utterance section has ended based on at least one of the power of the first and the second voice signals in each frame on and after the start of the utterance section.

For example, the utterance section end detection unit 27 compares the power of the frame of a voice signal (hereinafter referred to as a focused voice signal) collected by a microphone closer to a speaker identified by the speaker identification unit 25 out of the microphones 11-1 and 11-2 with a threshold value for detection of an utterance section. If the power of the focused voice signal in the immediately preceding frame is equal to or higher than the threshold value of utterance section detection, and the power of the focused voice signal in the current frame is less than the threshold value for utterance section detection, the utterance section end detection unit 27 determines that the utterance section has ended in the immediately preceding frame.

Alternatively, if a predetermined number of frames having power of the focused voice signal less than the threshold value for utterance section detection continue, the utterance section end detection unit 27 may determine that the utterance section has ended in the immediately preceding frame of the frame in which the power of the focused voice signal has first become less than the threshold value for utterance section detection.

Alternatively, the utterance section end detection unit 27 may perform any one of the utterance section end detection processing described above on each of the first voice signal and the second voice signal. If any one of or both of the first voice signal and the second voice signal satisfy the condition determined that the utterance section has ended, the utterance section end detection unit 27 may determine that the utterance section has ended.

If the threshold value for utterance section detection is updated by the start timing modification unit 26, the utterance section end detection unit 27 ought to use the updated threshold value. In this case, when a start of an utterance section is detected again after a determination is made that an utterance section has ended once, a threshold value based on the estimated noise component calculated by the threshold value setting unit 23 ought to be used.

When the utterance section end detection unit 27 detects an end of an utterance section, the utterance section end detection unit 27 notifies the voice processing unit 28 of the incidence.

When a start of an utterance section is detected, the voice processing unit 28 performs voice processing corresponding to a speaker identified as being uttering. At that time, the voice processing unit 28 may perform voice processing on any of the first and the second voice signals. However, for example, the voice processing ought to be performed on a voice signal collected by a microphone closer to the identified speaker out of the microphone 11-1 and the microphone 11-2. It is assumed that the signal-to-noise ratio of a voice signal collected by a microphone positioned closer to a speaker who is uttering is higher than the signal-to-noise ratio of a voice signal collected by a microphone positioned farther from the speaker who is uttering. Thus, by performing voice processing on a voice signal collected by a microphone positioned closer to a speaker identified as being uttering, it is possible for the voice processing unit 28 to obtain a more suitable voice processing result.

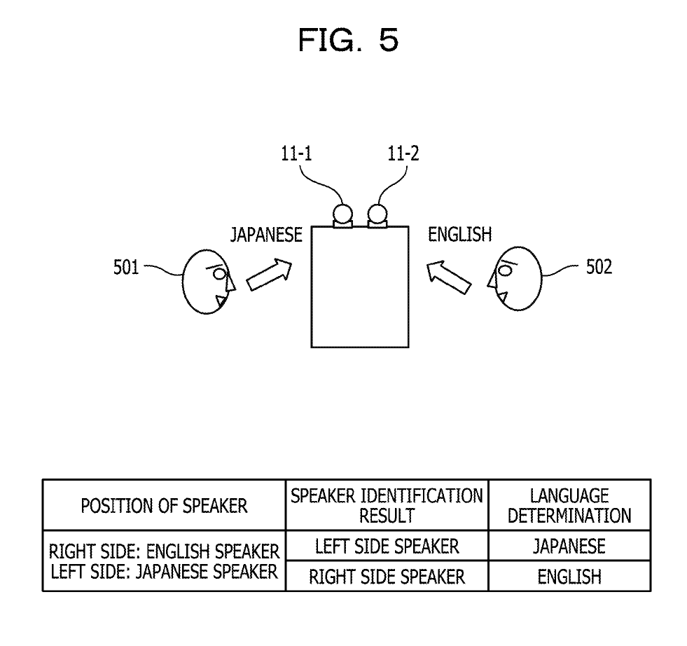

FIG. 5 is a diagram illustrating an example of a corresponding relationship between a speaker and voice processing. In the present embodiment, it is assumed that a first speaker 501 positioned closer to a microphone 11-1 speaks Japanese, whereas a second speaker 502 positioned closer to a microphone 11-2 speaks English. Accordingly, if an identified speaker is the first speaker 501, the voice processing unit 28 performs voice recognition processing with Japanese as a target language on the first voice signal and performs automatic translation processing from Japanese to English on the recognized utterance contents. On the other hand, if an identified speaker is the second speaker 502, the voice processing unit 28 performs voice recognition processing with English as a target language on the second voice signal and performs automatic translation processing from English to Japanese on the recognized utterance contents.

For example, the voice processing unit 28 extracts a plurality of feature quantities that represent features of the voice of the speaker from each frame of the voice signal to be processed in order to recognize the contents uttered by a speaker during an utterance section. For such feature quantities, for example, Mel frequency cepstrum coefficients having a predetermined order are used. The voice processing unit 28 applies, for example, the feature quantity of each frame to an acoustic model based on a hidden Markov model so as to recognize a phoneme sequence in an utterance section. The voice processing unit 28 refers to a word dictionary representing a phoneme sequence for each word and detects a combination of words that match the phoneme sequence of the utterance section so as to recognize the utterance contents in the utterance section. The voice processing unit 28 performs automatic translation processing on the combination of words in accordance with the utterance contents and translates the utterance contents into another language. The voice processing unit 28 may apply any one of the various automatic translation methods as the automatic translation processing. The voice processing unit 28 displays a character string in accordance with the translated utterance contents on the display device 15. Alternatively, the voice processing unit 28 may apply the voice synthesis processing on the translated character string to generate a synthesized voice signal corresponding to the character string and play back the synthesized voice signal via a speaker (not illustrated in the figure).

When it is assumed that there are three speakers, and if an identified speaker is neither the first speaker nor the second speaker, the voice processing unit 28 may perform the voice recognition processing for a language that is neither Japanese nor English on any one of the first and the second voice signals in the utterance section. Alternatively, if the identified speaker is neither the first speaker nor the second speaker, the voice processing unit 28 may perform the voice recognition processing of the language applied the last time.

After the voice processing is started, and before the voice processing unit 28 is notified of the end of an utterance section, if the speaker identification unit 25 notifies the voice processing unit 28 of the identified speaker once again, and the speaker notified last time differs from the speaker notified once again, the voice processing unit 28 stops the voice processing that has been already started. The voice processing unit 28 performs voice processing on the speaker notified once again. Thereby, in the case where start timing of an utterance section is mistakenly detected so that an identified speaker is mistaken, erroneous continuation of the voice processing corresponding to the identified speaker is avoided.

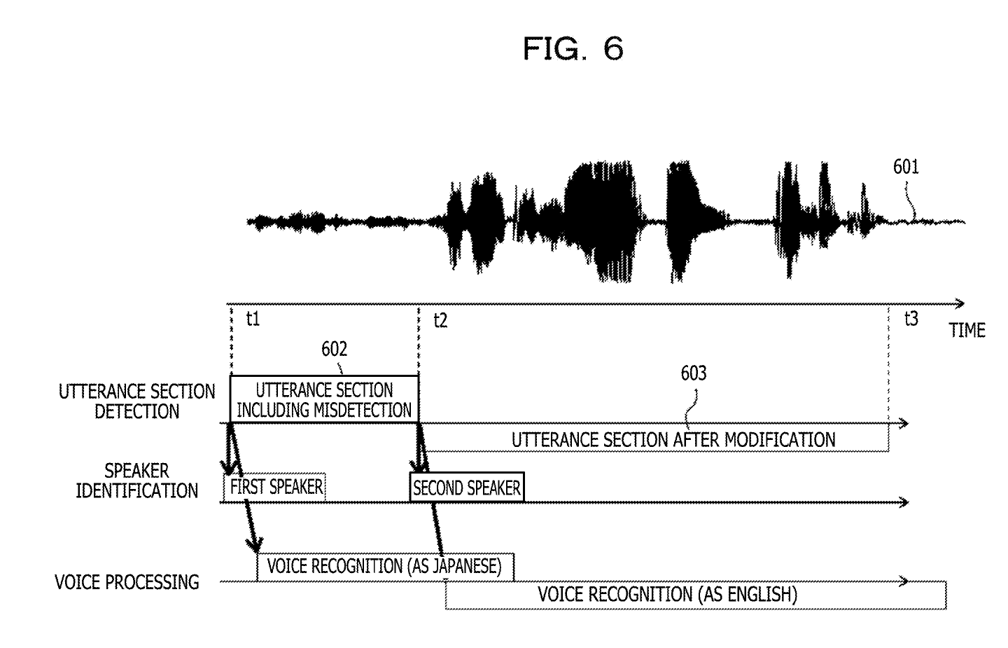

FIG. 6 is a diagram illustrating an example of a relationship between utterance section start timing and voice processing. In FIG. 6, the horizontal axis represents time. A waveform 601 is an example of one of the waveforms of the first and the second voice signals. In this example, it is assumed that the voice signal includes only a noise component and does not includes a voice of a speaker from time t1 to time t2. On the other hand, it is assumed that a speaker closer to the microphone 11-2 is uttering from time t2 to time t3.

It is assumed that a start of an utterance section is mistakenly detected at time t1, and a determination that the first speaker closer to the microphone 11-1 is uttering. In this case, in a section 602 which is detected mistakenly, the voice processing unit 28 performs voice recognition processing with Japanese as a recognition target. If the start of the utterance section is not modified, voice recognition processing with Japanese as the recognition target continues on and after time t2, at which an actual utterance has been started, and thus the utterance contents of a speaker is not correctly recognized.

On the other hand, in the present embodiment, the start timing of an utterance section is modified at time t2, and a speaker who is uttering at the modified start timing of an utterance section is identified once again. Thus, in an actual utterance section 603, voice recognition processing is performed with English as a recognition target, corresponding to the second speaker closer to the microphone 11-2, who is actually uttering. Accordingly, it is possible for the voice processing unit 28 to correctly recognize the utterance contents of a speaker who is actually uttering. The voice recognition processing with Japanese as a recognition target for the mistakenly detected section is stopped at the modified start timing of the utterance section.

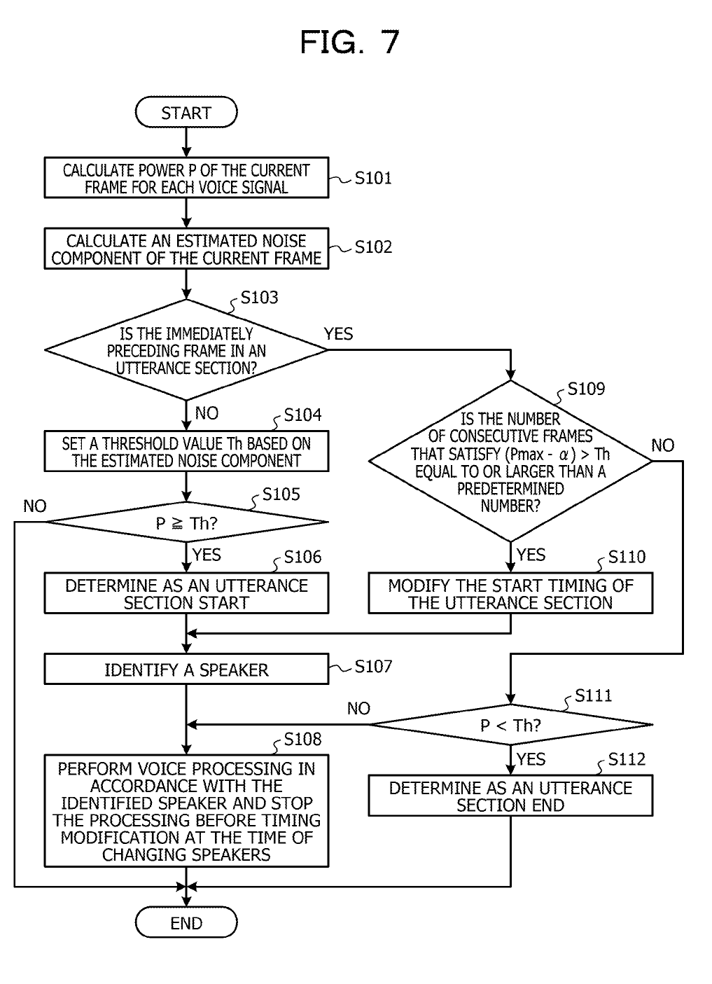

FIG. 7 is a flowchart of operation of the voice processing according to the present embodiment. The processor 13 performs voice processing for each frame in accordance with the operation of the flowchart.

The power calculation unit 21 calculates power P of the current frame for each of the first and the second voice signals (step S101). The noise estimation unit 22 calculates an estimated noise component in the current frame based on the power P of the current frame and an estimated noise component in the immediately preceding frame for each of the first and the second voice signals (step S102).

The threshold value setting unit 23 determines whether or not the immediately preceding frame is in the utterance section (step S103). If the immediately preceding frame is outside of the utterance section (step S103: No), the threshold value setting unit 23 sets a threshold value Th based on the estimated noise component for each of the first and the second voice signals (step S104). The utterance section start detection unit 24 determines whether or not the power P of the current frame is equal to or higher than the threshold value Th for each of the first and the second voice signals (step S105).

If the power P of the current frame for both the first and the second voice signals is less than the threshold value Th (step S105: No), the utterance section start detection unit 24 determines that the current frame is not included in the utterance section. The processor 13 terminates the voice processing. On the other hand, if the power P of the current frame for at least one of the first and the second voice signals is equal to or higher than the threshold value Th (step S105: Yes), the utterance section start detection unit 24 determines that an utterance section has started from the current frame (step S106). The utterance section start detection unit 24 detects the current frame as start timing of an utterance section. The speaker identification unit 25 identifies a speaker who has uttered in the started utterance section based on the first and the second voice signals (step S107). Further, the voice processing unit 28 performs processing in accordance with the identified speaker for any one of the first and the second voice signals (step S108). After that, the processor 13 terminates the voice processing in the current frame.

In step S103, if the immediately preceding frame is included in the utterance section (step S103: Yes), start timing of an utterance section has already been detected. Thus, the start timing modification unit 26 determines whether or not a predetermined number of frames in which the threshold value Th is less than a value produced by subtracting a predetermined power difference α from the maximum value Pmax of power after the start of the utterance section continue for each of the first and the second voice signals (step S109).

In the current frame for at least one of the first and the second voice signals, if the number of consecutive frames that satisfy a relationship of (Pmax−α)>Th is equal to or larger than a predetermined number (step S109: Yes), the start timing modification unit 26 updates the threshold value Th with (Pmax−α). The start timing modification unit 26 updates the start timing of the utterance section with the timing of the first frame out of the consecutive frames (step S110). After that, the processor 13 performs the processing on and after step S107. In this case, in step S108, if the identified speakers differ before and after the start timing of the utterance section, the voice processing unit 28 stops the voice processing that has been performed before the modification of the start timing of the utterance section.

On the other hand, in the current frame for both the first and the second voice signals, if the number of consecutive frames that satisfy a relationship of (Pmax−α)>Th is less than a predetermined number (step S109: No), the start timing modification unit 26 does not modify the start timing of the utterance section. On the other hand, the utterance section end detection unit 27 determines whether or not the power P of the current frame of a voice signal to be subjected to the voice processing by the voice processing unit 28 out of the first and the second voice signals is less than the threshold value Th (step S111). If the power P is less than the threshold value Th (step S111: Yes), the utterance section end detection unit 27 determines that the utterance section ended in the immediately preceding frame (step S112). The processor 13 notifies the voice processing unit 28 of the end of the utterance section. On the other hand, if the power P is equal to or higher than the threshold value Th (step S111: No), the utterance section end detection unit 27 determines that the current frame is included in the utterance section. The processor 13 performs the processing of step S108.

As described above, when a start of an utterance section is detected, the voice processing apparatus identifies a speaker who has uttered in the utterance section and performs the voice processing in accordance with the identified speaker on at least one of the first and the second voice signals. After a start of an utterance section was detected once, if the start timing of the utterance section is modified, the voice processing apparatus identifies again a speaker who uttered in the utterance section out of a plurality of speakers at the modified start timing. The voice processing apparatus performs the voice processing in accordance with the speaker identified again on at least one of the first and the second voice signals. Thus, even if the timing when any one of a plurality of speakers of each voice signal is mistakenly detected, it is possible for the voice processing apparatus utterance to apply the processing in accordance with the speaker on the voice signal.

According to a variation, the voice processing unit 28 may perform processing other than the voice recognition processing and the automatic translation processing. For example, it is assumed that an echo tends to occur in the surroundings of the first speaker and there is a noise source in the surroundings of the second speaker. In this case, in the case where a determination is made that he first speaker is uttering, the voice processing unit 28 may perform echo removal processing on at least one of the first and the second voice signals in the utterance section. On the other hand, if a determination is made that the second speaker is uttering, the voice processing unit 28 may perform noise removal processing on at least one of the first and the second voice signals in the utterance section.

The utterance section start detection unit 24 and the start timing modification unit 26 may detect start timing of an utterance section and perform modification determination of the start timing based on the feature quantity representing the voice of a speaker included in the voice signal other than the power of each frame. For example, the utterance section start detection unit 24 calculates a pitch gain representing the intensity of the periodicity of the voice from each frame of the first and the second voice signals. For at least one of the first and the second voice signals, if the pitch gain of the immediately preceding frame becomes less than a threshold value, and the pitch gain of the current frame becomes equal to or higher than the threshold value, the utterance section start detection unit 24 may detect a start of an utterance section. The pitch gain g_{pitch} is calculated, for example, in accordance with the following expression.

$${g}_{pitch} = \frac{C ( {d}_{max} )}{{\sum }_{n = 0}^{N - 1} {s}_{k} ( n ) \cdot {s}_{k} ( n )} \\ C ( d ) = {\sum }_{n = 0}^{N - 1} {s}_{k} ( n ) \cdot {s}_{k} ( n - d ) \\ ( d = {d}_{low} , … , {d}_{high} ) \qquad ( 3 )$$

where C(d) denotes a long-term autocorrelation of a focused voice signal. The sign dϵ{d_{low}, . . . , d_{high}} denotes the amount of delay. Sk(n) denotes the n-th signal value of the current frame k. The sign N denotes the total number of sampling points included in the frame. If (n−d) is negative, a signal value (that is to say, if there are no overlaps of frame sections, Sₖ₋₁(N−(n−d))) corresponding to the immediately preceding frame is used as Sₖ(n−d). The range {d_{low}, . . . , d_{high}} of the amount of delay d is set so as to include the amount of delay corresponding to the fundamental frequency (100 to 300 Hz) of a human voice. This is because the pitch gain becomes highest at the fundamental frequency. For example, if the sampling rate is 16 kHz, the settings are d_{low}=40 and d_{high}=286. Further, dₘₐₓ is the amount of delay corresponding to the maximum value C (dₘₐₓ) of the long-term autocorrelation C(d), and the amount of delay corresponds to the pitch period.

Commonly, a pitch gain becomes highest immediately after an utterance is started and becomes small as the utterance continues. Thus, for at least one of the first and the second voice signals, the start timing modification unit 26 compares the maximum value of the pitch gain of a predetermined number of frames immediately after the detection of a start of an utterance section and the pitch gain of each frame after detection of a start of an utterance section. If the start timing modification unit 26 detects a frame in which the pitch gain becomes larger than the maximum value of the pitch gain by a value equal to or larger than a predetermined offset value, the start timing modification unit 26 ought to modify the start timing of the utterance section with the frame.

In the case of this variation, the utterance section end detection unit 27 may determine that the utterance section has ended in the first frame in which the pitch gain becomes less than the threshold value for both the first and the second voice signals after the detection of an utterance section. Alternatively, if the pitch gain becomes less than the threshold value in a predetermined number of consecutive frames for both the first and the second voice signals, the utterance section end detection unit 27 may determine that the utterance section has ended in the first frame in which the pitch gain becomes less than the threshold value. The utterance section end detection unit 27 may also determine that the utterance section has ended in the first frame in which both the power and the pitch gain become less than the threshold values.

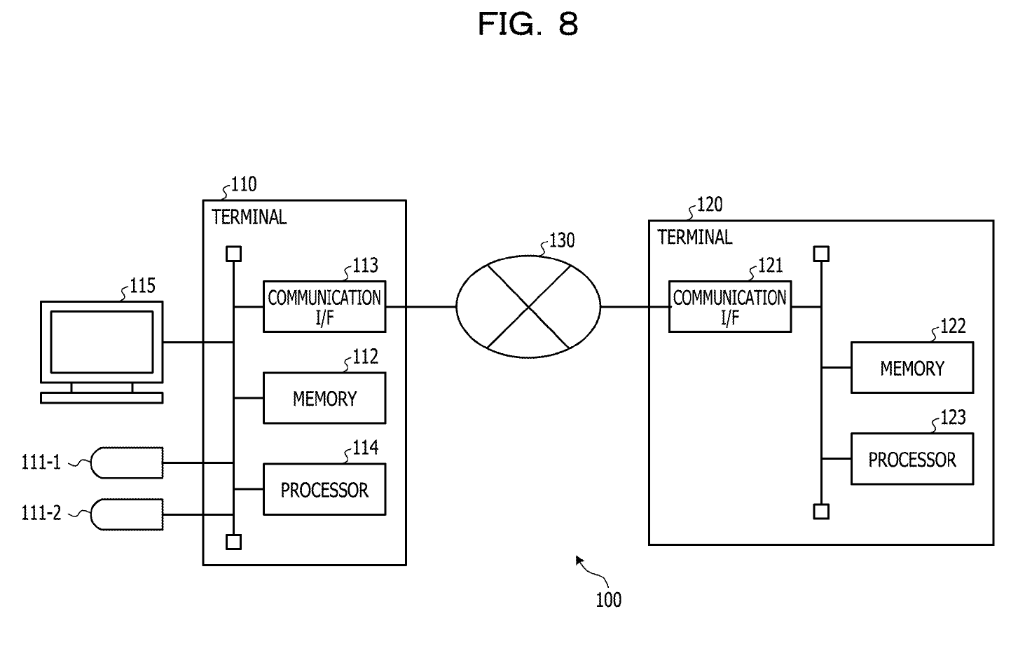

A voice processing apparatus according to the above-described embodiment or variation may be implemented in a server client system. FIG. 8 is a schematic configuration diagram of a server client system in which a voice processing apparatus according to the embodiment or the variation thereof is implemented. A server client system 100 includes a terminal 110 and a server 120, and the terminal 110 and the server 120 are capable of communicating with each other via a communication network 130. A plurality of terminals 110 may exist in the server client system 100. In the same manner, a plurality of servers 120 may exist in the server client system 100.

The terminal 110 includes two microphones 111-1 and 111-2, a memory 112, a communication interface 113, a processor 114, and a display device 115. The microphone 111, the memory 112, and the communication interface 113 are, for example, connected with the processor 114 via a bus.

The microphones 111-1 and 111-2 are examples of individual voice input units. The microphone 111-1 obtains a first voice signal, which is an analog signal, and outputs the first voice signal to an A/D converter (not illustrated in the figure). The A/D converter outputs a digitized first voice signal to the processor 114. In the same manner, the microphone 111-2 obtains a second voice signal, which is an analog signal, and outputs the second voice signal to an A/D converter (not illustrated in the figure). The A/D converter outputs a digitalized second voice signal to the processor 114.

The memory 112 includes, for example, a non-volatile semiconductor memory and a volatile semiconductor memory. The memory 112 stores a computer program for controlling the terminal 110, identification information of the terminal 110, various kinds of data and computer programs used by the utterance section detection processing, and the like.

The communication interface 113 includes an interface circuit for connecting the terminal 110 to the communication network 130. The communication interface 113 transmits a voice signal received from the processor 114 to the server 120 with the identification information of the terminal 110 via the communication network 130.

The processor 114 includes a CPU and a peripheral circuit thereof. The processor 114 transmits the first and the second voice signals to the server 120 with the identification information of the terminal 110 via the communication interface 113 and the communication network 130. The processor 114 displays a processing result of each voice signal received from the server 120 to the display device 115 or plays back a synthesized voice signal corresponding to the processing result via a speaker (not illustrated in the figure).

The display device 115 is, for example, a liquid crystal display or an organic EL display and displays a processing result for each voice signal.

The server 120 includes a communication interface 121, a memory 122, and a processor 123. The communication interface 121 and the memory 122 are connected to the processor 123 via a bus.

The communication interface 121 includes an interface circuit for connecting the server 120 to the communication network 130. The communication interface 121 passes the first and the second voice signals and the identification information of the terminal 110 from the terminal 110 to the processor 123 via the communication network 130.

The memory 122 includes, for example, a non-volatile semiconductor memory and a volatile semiconductor memory. The memory 122 stores a computer program for controlling the server 120, and the like. The memory 122 may store a computer program for performing voice processing and each voice signal received from each terminal.

The processor 123 includes a CPU and a peripheral circuit thereof. The processor 123 realizes each function of the processor of the voice processing apparatus according to the embodiment or the variation. The processor 123 transmits a voice processing result of the received first and second voice signals to the terminal 110 via the communication interface 121 and the communication network 130.

The processor 114 of the terminal 110 may perform processing other than that of the voice processing unit 28 out of each function of the processor of the voice processing apparatus according to the embodiment or the variation. In this case, the terminal 110 ought to transmit at least any one of the first and the second voice signals in the utterance section and information representing the identified speaker to the server 120. If the terminal 110 has modified start timing of an utterance section, the terminal 110 transmits information representing the modified start timing of the utterance section and the re-identified speaker to the server 120. The processor 123 of the server 120 ought to perform the processing of the voice processing unit 28 on at least one of the first and the second voice signals.

A computer program that causes a computer to realize each function of the processor of the utterance section detection apparatus according to the embodiment or the variation may be provided in the recorded form on a computer-readable medium, such as a magnetic recording medium or an optical recording medium.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A voice processing apparatus comprising:
a memory; and
a processor coupled to the memory and configured to
execute an utterance section start detection process that includes based on at least one of a first voice signal generated by a first voice input unit and a second voice signal generated by a second voice input unit, detecting start timing of utterance by any one of a plurality of speakers,
execute a start timing modification process that includes based on at least one of the first voice signal and the second voice signal on and after the detected start timing of utterance, determining whether or not to modify the start timing of utterance,
execute a speaker identification process that includes when the start timing of utterance is modified, based on the first voice signal and the second voice signal on and after the modified start timing of utterance, identifying a speaker who has uttered out of the plurality of speakers, and
execute a voice process that includes executing a process in accordance with the identified speaker on at least one of the first voice signal and the second voice signal on and after the modified start timing of utterance.

2. The voice processing apparatus according to claim 1,
wherein when the start timing of utterance is detected, the speaker identification process is configured to identify a speaker who has uttered out of the plurality of speakers based on the first voice signal and the second voice signal on and after the timing,
wherein the voice process is configured to execute a first process in accordance with the speaker identified when the start timing of utterance is detected on at least one of the first voice signal and the second voice signal, and
wherein the voice process is configured to stop the first process when the start timing of utterance is modified.

3. The voice processing apparatus according to claim 2,
wherein when the speaker identified at detection time of the start timing of utterance differs from the speaker identified at modification time of the start timing of utterance, the voice process is configured to stop the first process.

4. The voice processing apparatus according to claim 1,
wherein the utterance section start detection process is configured to
calculate a pitch gain representing an intensity of periodicity of the voice signal for each frame having a predetermined length produced by dividing the voice signal for each of the first voice signal and the second voice signal,
detect a frame having the pitch gain equal to or higher than a predetermined threshold value for at least one of the first voice signal and the second voice signal as the start timing of utterance,
wherein the start timing modification process is configured to
modify the frame as the start timing of utterance when a frame having the pitch gain equal to or greater than the pitch gain when the start timing of utterance was detected with a predetermined offset or more for at least one of the first voice signal and the second voice signal.

5. A voice processing method comprising:
executing an utterance section start detection process that includes based on at least one of a first voice signal generated by a first voice input unit and a second voice signal generated by a second voice input unit, detecting start timing of utterance by any one of a plurality of speakers,
executing a start timing modification process that includes based on at least one of the first voice signal and the second voice signal on and after the detected start timing of utterance, determining whether or not to modify the start timing of utterance,
executing a speaker identification process that includes when the start timing of utterance is modified, based on the first voice signal and the second voice signal on and after the modified start timing of utterance, identifying a speaker who has uttered out of the plurality of speakers, and
executing a voice process that includes executing a process in accordance with the identified speaker on at least one of the first voice signal and the second voice signal on and after the modified start timing of utterance.

6. The voice processing method according to claim 5,
wherein when the start timing of utterance is detected, the speaker identification process is configured to identify a speaker who has uttered out of the plurality of speakers based on the first voice signal and the second voice signal on and after the timing,
wherein the voice process is configured to execute a first process in accordance with the speaker identified when the start timing of utterance is detected on at least one of the first voice signal and the second voice signal, and
wherein the voice process is configured to stop the first process when the start timing of utterance is modified.

7. The voice processing method according to claim 6,
wherein when the speaker identified at detection time of the start timing of utterance differs from the speaker identified at modification time of the start timing of utterance, the voice process is configured to stop the first process.

8. The voice processing method according to claim 5,
wherein the utterance section start detection process is configured to
calculate a pitch gain representing an intensity of periodicity of the voice signal for each frame having a predetermined length produced by dividing the voice signal for each of the first voice signal and the second voice signal,
detect a frame having the pitch gain equal to or higher than a predetermined threshold value for at least one of the first voice signal and the second voice signal as the start timing of utterance,
wherein the start timing modification process is configured to
modify the frame as the start timing of utterance when a frame having the pitch gain equal to or greater than the pitch gain when the start timing of utterance was detected with a predetermined offset or more for at least one of the first voice signal and the second voice signal.

9. A non-transitory computer-readable storage medium for storing a program which causes a processor to perform processing for voice processing, the processing comprising:
executing an utterance section start detection process that includes based on at least one of a first voice signal generated by a first voice input unit and a second voice signal generated by a second voice input unit, detecting start timing of utterance by any one of a plurality of speakers,
executing a start timing modification process that includes based on at least one of the first voice signal and the second voice signal on and after the detected start timing of utterance, determining whether or not to modify the start timing of utterance,
executing a speaker identification process that includes when the start timing of utterance is modified, based on the first voice signal and the second voice signal on and after the modified start timing of utterance, identifying a speaker who has uttered out of the plurality of speakers, and
executing a voice process that includes executing a process in accordance with the identified speaker on at least one of the first voice signal and the second voice signal on and after the modified start timing of utterance.

10. The non-transitory computer-readable storage medium according to claim 9,
wherein when the start timing of utterance is detected, the speaker identification process is configured to identify a speaker who has uttered out of the plurality of speakers based on the first voice signal and the second voice signal on and after the timing,
wherein the voice process is configured to execute a first process in accordance with the speaker identified when the start timing of utterance is detected on at least one of the first voice signal and the second voice signal, and
wherein the voice process is configured to stop the first process when the start timing of utterance is modified.

11. The non-transitory computer-readable storage medium according to claim 10,
wherein when the speaker identified at detection time of the start timing of utterance differs from the speaker identified at modification time of the start timing of utterance, the voice process is configured to stop the first process.

12. The non-transitory computer-readable storage medium according to claim 9,
wherein the utterance section start detection process is configured to
calculate a pitch gain representing an intensity of periodicity of the voice signal for each frame having a predetermined length produced by dividing the voice signal for each of the first voice signal and the second voice signal,
detect a frame having the pitch gain equal to or higher than a predetermined threshold value for at least one of the first voice signal and the second voice signal as the start timing of utterance,
wherein the start timing modification process is configured to
modify the frame as the start timing of utterance when a frame having the pitch gain equal to or greater than the pitch gain when the start timing of utterance was detected with a predetermined offset or more for at least one of the first voice signal and the second voice signal.
